(19) United States
(12) Patent Application Publication
(10) Pub. No.: US 2013/0298171 A1
(43) Pub. Date: Nov. 7, 2013

(54) DEVICE FOR GENERATING CONTENT DATA, METHOD FOR GENERATING CONTENT DATA, AND RECORDING MEDIUM

(71) Applicants: Mitsuhiko Takeda, Osaka-shi (JP); Kohji Tashima, Osaka-shi (JP); Hiroyuki Hayashi, Osaka-shi (JP); Takahiro Mori, Osaka-shi (JP)

(72) Inventors: Mitsuhiko Takeda, Osaka-shi (JP); Kohji Tashima, Osaka-shi (JP); Hiroyuki Hayashi, Osaka-shi (JP); Takahiro Mori, Osaka-shi (JP)

(73) Assignee: SHARP KABUSHIKI KAISHA, Osaka-shi, Osaka (JP)

(21) Appl. No.: 13/988,191

(22) PCT Filed: Nov. 18, 2011
(86) PCT No.: PCT/JP2011/076629

§ 371 Date: Jun. 28, 2013

(30) Foreign Application Priority Data
Nov. 18, 2010 (JP) 2010-257465

(51) Int. Cl. H04N 21/2343

(52) U.S. Cl. CPC H04N 21/234309
USPC 725/74

(57) ABSTRACT

To effectively reduce the load on a device involved in converting the format of content data. A storage unit (14) stores format information that includes at least information about the container format of first content data and encoding information about multimedia data included in the first content data; and a container converter (16) converts the second container format of second content data into the first container format of the first content data on the basis of information stored in the storage unit (14), without decoding the multimedia data included in the second content data and without encoding the multimedia data obtained as a result of the decoding, whereby the first content data is generated.

### TECHNICAL FIELD

The present invention relates to a device for generating content data generating content data, a method for generating content data, a computer program characterized by driving a computer to execute the content data generating method, and a computer-readable recording medium characterized by recording the computer program.

### BACKGROUND ART

An industry group called DLNA (Digital Living Network Alliance) (registered trademark) has recently developed a guideline for sharing contents such as video among information devices connected to a home network.

This guideline defines formats usable by digital appliances such as digital video recorders and digital televisions and portable terminals such as information devices including portable telephones. FIG. 13 is a diagram for explaining the sharing of contents among information devices.

As depicted in FIG. 13, for recorded contents of digital video recorder 200 and reproducible contents of a digital television 201, mandatory formats (MPEG2-PS, MPEG-2(HD), L-PCM/AC-3/MPEG-1/-2 Audio), and (MPEG2-TS, MPEG-2(HD), AAC) are defined. In the notation (A, B, C), A denotes a type of a container format while B and C denote encode information of video data and audio data or, specifically, a type of a video codec and a type of an audio codec, respectively. An option format (MPEG2-TS, H.264(HD), AAC) is defined in the digital video recorder 200 and the digital television 201 in some cases.

As described above, in the example of FIG. 13, the formats of recorded contents of the digital video recorder 200 match the formats of reproducible contents of the digital television 201 and, therefore, the digital television 201 can directly reproduce the contents recorded by the digital video recorder 200.

Similarly, for recorded contents and reproducible contents of portable telephones 202 and 203, a mandatory format (MP4, H.264(CIF), AAC) is defined. An option format (MP4, H.264(HD), AAC) is defined in the portable telephones 202 and 203 in some cases.

As described above, in the example of FIG. 13, the formats of recorded contents and the formats of reproducible contents of the portable telephones 202 and 203 match each other and, therefore, the portable telephone 203 can reproduce the contents recorded by the other portable telephone 202.

However, no format of recorded contents of the digital video recorder 200 matches the formats of reproducible contents of the portable telephone 203. No format of recorded contents of the portable telephone 202 matches the formats of reproducible contents of the digital television 201. Therefore, it is difficult to share contents between digital appliances such as the digital video recorder 200 and the digital television 201 and portable terminals 202, 203 such as portable telephones in this situation.

To solve such a problem, techniques are proposed to enable sharing of contents between apparatuses having different formats by transcoding the contents (see, e.g., Patent Document 1 to 3). Transcoding is a process of decoding contents to uncompress the compressed contents and re-encoding the uncompressed contents to generate contents in a desired format.

FIG. 14 is a diagram for explaining transcoding. In an example of FIG. 14, a portable terminal content data 300 in a format (MP4, H.264(HD), AAC) is transcoded to a digital appliance content data 400 in a format (MPEG-2 PS, MPEG-2 (SD), L-PCM).

The transcoding is executed by a data separating portion 301, a video data decoder 302, an audio data decoder 303, flame buffers 304, 305, a resizer 306, a video data encoder 307, an audio data encoder 308, and a data multiplexing portion 309.

The data separating portion 301 is a processing portion for separating video data and audio data from the portable terminal content data 300. The video data decoder 302 is a processing portion for decoding the video data when the video codec is H.264 (HD). The audio data decoder 303 is a processing portion for decoding the audio data when the audio codec is AAC.

The flame buffer 304 is a buffer temporarily storing the video data decoded by the video data decoder 302. The flame buffer 305 is a buffer temporarily storing the audio data decoded by the audio data decoder 303. The resizer 306 is a processing portion for changing a size of image of video data as needed.

The video data encoder 307 is a processing portion for encoding the video data output from the resizer 306 to generate video data with the video data codec “MPEG-2(SD)”. The audio data encoder 308 is a processing portion for reading the audio data stored in the frame buffer 305 and encoding the read audio data to generate video data using the audio codec “L-PCM”. The data multiplexing portion 309 is a processing portion for multiplexing video data and audio data to generate content data having the video data and the audio data contained in the container “MPEG-2 PS”.

As described above, in the transcoding, video data and audio data are decoded and then re-encoded to generate content data reproducible by a player apparatus.

### PRIOR ART DOCUMENTS

### Patent Documents

Patent Document 1: Japanese Laid-Open Patent Publication No. 2006-311267
Patent Document 2: Japanese Laid-Open Patent Publication No. 2009-188690
Patent Document 3: Japanese Laid-Open Patent Publication No. 2007-336214

### SUMMARY OF THE INVENTION

### Problems to be Solved by the Invention

However, since a larger load is applied to an apparatus at the time of execution of transcoding, the conventional techniques are problematically difficult to be implemented in an apparatus without high processing capability such as a portable terminal, for example. In other words, the transcoding includes processes such as decoding and encoding associated with a larger load and therefore requires dedicated hardware executing these processes, causing a problem that the manufacturing cost of the apparatus is increased.

Even if the transcoding is executed by a stationary apparatus, a larger load is applied to the apparatus and, therefore, instead of executing the transcoding in real time when content data is reproduced, a process is required such as executing the transcoding in advance and storing format-converted content data into a hard disc device. Therefore, a storage capacity of the hard disc device may quickly become insufficient and cause trouble in subsequent format conversion processes.

The present invention was conceived in view of the problems and it is therefore an object of the present invention to provide a device for generating content data that effectively reduces a load of an apparatus pertaining to format conversion of content data, a method for generating content data, computer program characterized by driving a computer to execute the method for generating content data, and a computer-readable recording medium characterized by recording the computer program.

### Means for Solving the Problems

To solve the above problems, a first technical means of the present invention is a device for generating content data generating first content data for a player apparatus by using a first container format, comprising:

a storage portion for storing format information at least including information of the first container format and encoded information of multimedia data included in the first content data; and

a container converting portion for generating the first content data by converting a second container format of a second content data into the first container format of the first content data based on the information stored in the storage portion without executing a decoding process of multimedia data included in the second content data and an encoding process of multimedia data acquired as a result of the decoding process.

A second technical means is the device for generating content data of the first technical means, further comprising a control portion for determining whether the first content data is generable by using the second content data based on the information stored in the storage portion, wherein the container converting portion generates the first content data only when the control portion determines that the first content data is generable.

A third technical means is the device for generating content data of the second technical means, further comprising a content analyzing portion for analyzing a format of the second content data, wherein the control portion determines whether the first content data is generable based on an analysis result conducted by the content analyzing portion.

A fourth technical means is the device for generating content data of anyone of the first to the third technical means, wherein the storage portion further stores model information of at least a type, a model, or a reproduction capability of the player apparatus, and wherein the control portion determines whether a list of the first content data is transmitted to the player apparatus based on the information stored in the storage portion.

A fifth technical means is the device for generating content data of any one of the first to the fourth technical means, wherein the container converting portion rewrites an identifier identifying a codec of the multimedia data to generate the first content data including the multimedia data with the identifier rewritten.

A sixth technical means is the device for generating content data of the fifth technical means, wherein the codec of the multimedia data is MPEG-4 AAC and wherein the codec corresponding to the identifier rewritten by the container converting portion is MPEG-2 AAC.

A seventh technical means is the device for generating content data of the sixth technical means, wherein the MPEG-4 AAC is a codec acquired by adding expanded functions to the MPEG-2 AAC, and wherein the container converting portion generates the first content data only when the expanded functions of the MPEG-4 AAC are not utilized in the second content data.

An eighth technical means is the device for generating content data of any one of the first to the seventh technical means, wherein the container converting portion generates the first content data by setting a time interval of alternate storage of video data and audio data included as the multimedia data in the first content data equal to or less than a predetermined time interval.

A ninth technical means is the device for generating content data of any one of the first to the eighth technical means, further comprising a content transmitting portion for transmitting the first content data generated by the container converting portion to the player apparatus connected via a network.

A tenth technical means is the device for generating content data of any one of the first to the eighth technical means, further comprising the player apparatus, wherein the player apparatus reproduces the first content data generated by the container converting portion.

An eleventh technical means is the device for generating content data of any one of the first to the eighth technical means, further comprising a content receiving portion for receiving the second content data from a server apparatus connected via a network, and a content transmitting portion for transmitting the first content data generated by the container converting portion to the player apparatus connected via the network.

A twelfth technical means is the device for generating content data of any one of the first to the eleventh technical means, wherein the second container format is MP4.

A thirteenth technical means is the device for generating content data of any one of the first to the twelfth technical means, wherein the first container format is MPEG2-TS.

A fourteenth technical means is the device for generating content data of any one of the first to the twelfth technical means, wherein the first container format is MPEG2-TTS.

A fifteenth technical means is a method for generating content data of generating first content data for a player apparatus by using a first container format, comprising:

an information reading step of reading format information at least including information of the first container format and encoded information of multimedia data included in the first content data from a storage portion; and

a container converting step of generating the first content data by converting a second container format of a second content data into the first container format of the first content data based on the information read at the information reading step without executing a decoding process of multimedia data included in the second content data and an encoding process of multimedia data acquired as a result of the decoding process.

A sixteenth technical means is a computer program which is run on a computer to execute the method for generating content data of the fifteenth technical means.

A seventeenth technical means is a computer readable recording medium recording the computer program of the sixteenth technical means.

### Effect of the Invention

According to the present invention, since format information is stored that at least includes information of the container format of content data and encode information of multimedia data included in the content data, and the container format is converted based on the stored container format information to generate the content data without executing a decoding process of the multimedia data stored in the content data and an encoding process of the multimedia data acquired as a result of the decoding process, the load of the apparatus pertaining to the format conversion of the content data can efficiently be reduced.

### BRIEF DESCRIPTION OF DRAWINGS

FIG. 1 is a diagram for explaining a content data generating process according to a first embodiment of the present invention.

FIG. 2 is a functional block diagram of a server apparatus according to the first embodiment.

FIG. 3 is a flowchart of an example of a process procedure of the content data generating process according to the first embodiment.

FIG. 4 is a diagram for explaining container format conversion or transcoding performed depending on a format of content data.

FIG. 5 is a diagram for explaining an example of a container format conversion process executed by a player apparatus.

FIG. 6 is a functional block diagram of the player apparatus performing container format conversion.

FIG. 7 is a diagram for explaining an example of a container format conversion process executed by a relay server apparatus.

FIG. 8 is a functional block diagram of the relay server apparatus performing container format conversion.

FIG. 9 is a diagram for explaining a content data generating process according to a second embodiment of the present invention.

FIG. 10 is a functional block diagram of a container converting portion in a server apparatus according to the second embodiment.

FIG. 11 is a diagram for explaining a process of changing a time interval of video data and audio data when the video data and the audio data are alternately stored in a container.

FIG. 12 is a functional block diagram of a container converting portion in a server apparatus according to the third embodiment.

FIG. 13 is a diagram for explaining sharing of contents among information devices.

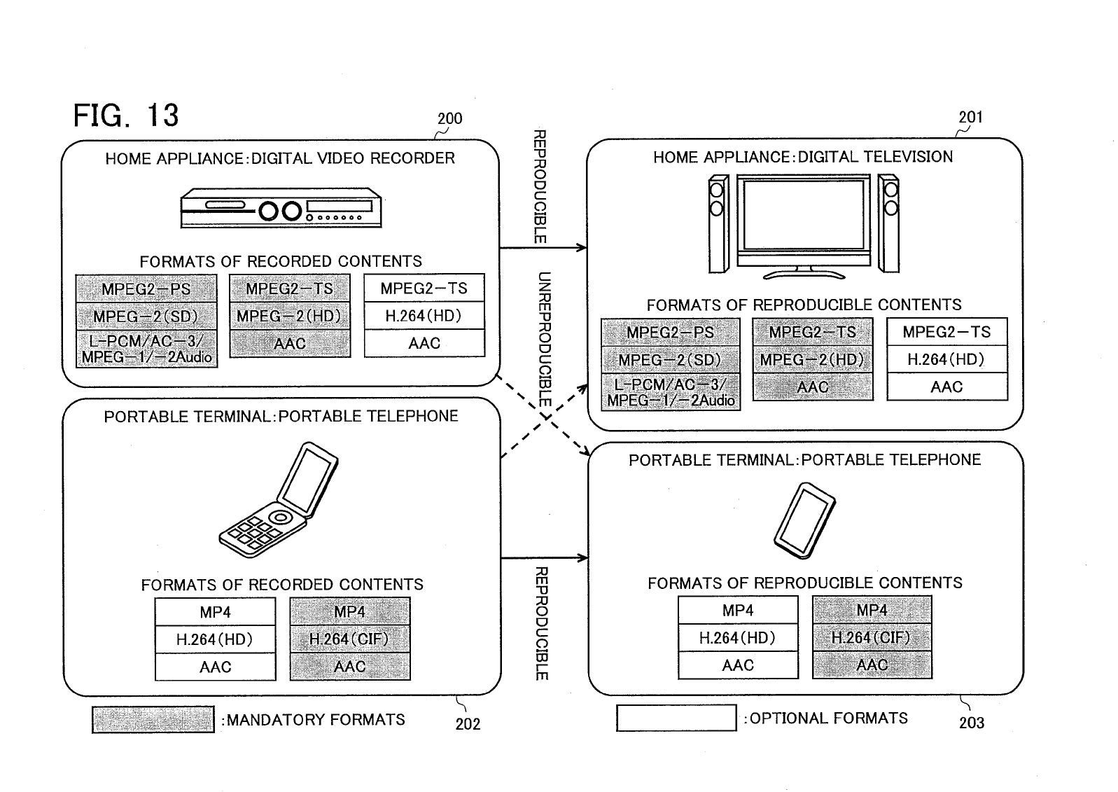

FIG. 14 is a diagram for explaining transcoding.

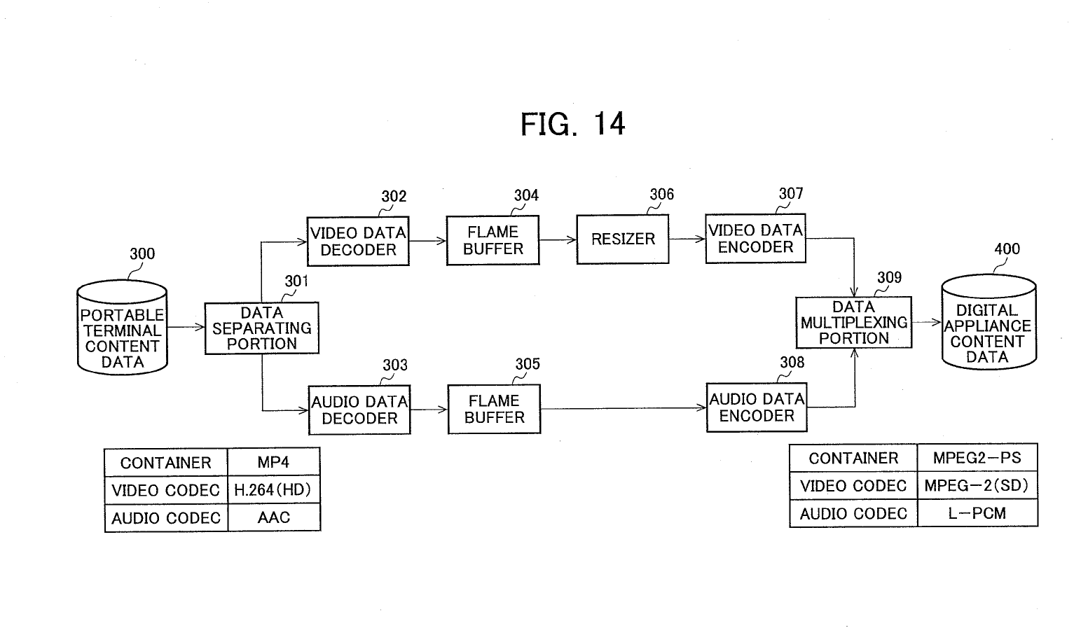

### MODES FOR CARRYING OUT THE INVENTION

Embodiments of the present invention will now be described in detail with reference to the drawings. In the following description, a server apparatus and a player apparatus are apparatuses such as portable terminals including portable telephones and digital devices including a digital video recorder and a digital television, and respectively refer to an apparatus providing content data including multimedia data such as video data and audio data, and an apparatus reproducing the content data.

### First Embodiment

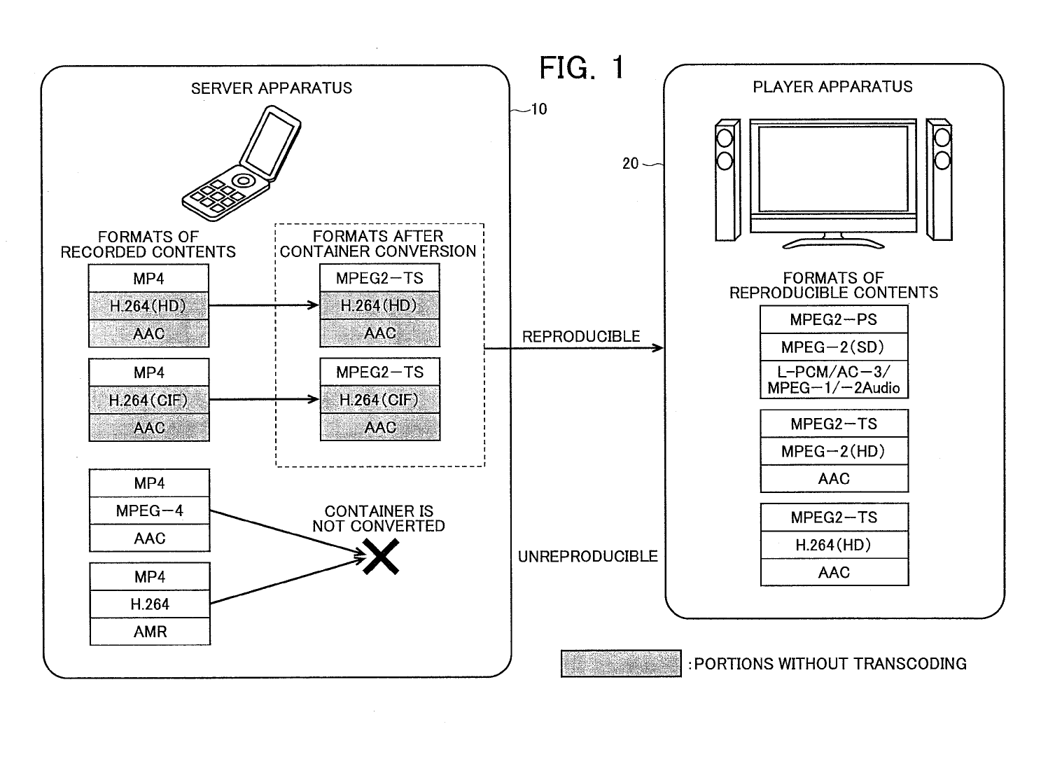

A content data generating process according to a first embodiment of the present invention will be described. FIG. 1 is a diagram for explaining the content data generating process according to the first embodiment of the present invention. FIG. 1 depicts an example in the case of reproducing recorded contents of a server apparatus 10 by a player apparatus 20. As described above, the server apparatus 10 provides content data reproducible by the player apparatus 20 to the player apparatus 20.

In the example depicted in FIG. 1, formats usable for recording contents by the server apparatus 10 include (MP4, H.264(HD), AAC), (MP4, H.264(CIF), AAC), (MP4, MPEG-4, AAC), and (MP4, H.264, AMR). In the notation (A, B, C), A denotes a type of a container format while B and C denote encode information of video data and audio data or, specifically, a type of a video codec and a type of an audio codec, respectively.

Formats usable for reproducing contents by the player apparatus 20 include (MPEG2-PS, MPEG-2(SD), L-PCM/AC-3/MPEG-1/-2 Audio), (MPEG2-TS, MPEG-2(HD), AAC), and (MPEG2-TS, H.264(HD), AAC).

Since no matching format exists between the formats of recorded contents of the server apparatus 10 and the formats of reproducible contents of the player apparatus 20, the player apparatus 20 cannot directly reproduce the contents recorded by the server apparatus 10.

Therefore, the server apparatus 10 executes a container format conversion process for a format of recorded contents having a video codec and an audio codec respectively matching a video codec and an audio codec of contents reproducible by the player apparatus 20, without executing a decoding process of video and audio data and an encoding process of the decoded video and audio data, to generate a format of contents reproducible by the player apparatus 20.

In the example of FIG. 1, for the format (MP4, H.264(HD), AAC) of recorded contents, the server apparatus 10 converts the container format from “MP4” into “MPEG2-TS” without executing the decoding and encoding processes of the video and audio data, thereby generating the format (MPEG2-TS, H.264(HD), AAC) of contents reproducible by the player apparatus 20.

For the format (MP4, H.264(CIF), AAC) of recorded contents, the server apparatus 10 converts the container format from “MP4” into “MPEG2-TS” without executing the decoding and encoding processes of the video and audio data.

In this case, the format (MPEG2-TS, H.264(CIF), AAC) of recorded contents after the container conversion is different from the format (MPEG2-TS, H.264(HD), AAC) of contents reproducible by the player apparatus 20 in that the video codec is H.264(CIF).

However, the video codec H.264(HD) is a higher-order standard of the video codec H.264(CIF) and supports the reproduction of video data of the video codec H.264(CIF). Therefore, the player apparatus 20 supporting the format (MPEG2-TS, H.264(HD), AAC) can reproduce the content data in the format (MP4, H.264(CIF), AAC).

The container format conversion process applies a very small load to the server apparatus 10 as compared to transcoding and can therefore easily be implemented in an apparatus without high processing capability such as a portable telephone. Since the container format conversion process can be executed in real time, it is no longer necessary to store content data with a container format converted in advance into a hard disc device in the case of performing streaming reproduction etc.

Although one of the container formats usable for reproducing contents by the player apparatus 20 is “MPEG2-TS” in this example, the container format may be another container format such as “MPEG2-TTS” with time stamp information added, for example. The same applies to the following description.

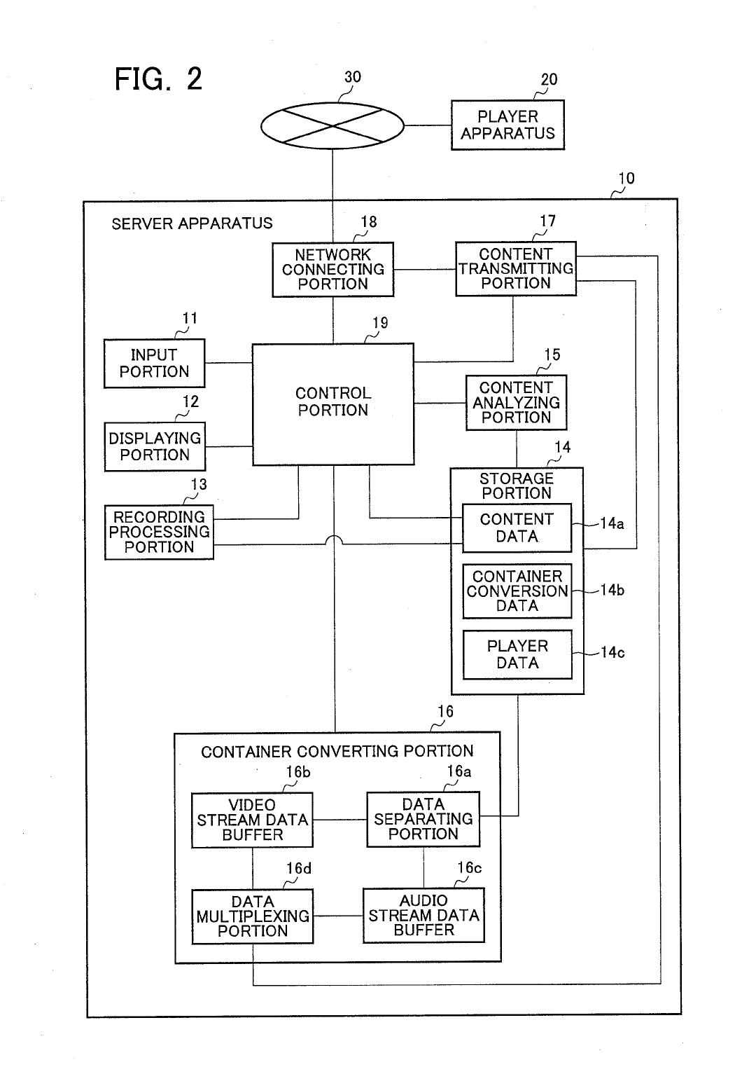

A configuration of the server apparatus 10 according to the first embodiment will be described. FIG. 2 is a functional block diagram of the server apparatus 10 according to the first embodiment. The server apparatus 10 is an apparatus generating content data having a container format converted for the player apparatus 20 by using container format information. As depicted in FIG. 2, the server apparatus 10 includes an input portion 11, a displaying portion 12, a recording processing portion 13, a storage portion 14, a content analyzing portion 15, a container converting portion 16, a content transmitting portion 17, a network connecting portion 18, and a control portion 19.

The input portion 11 is an input device such as operation buttons accepting input from a user. The displaying portion 12 is a displaying device such as a liquid-crystal display. The recording processing portion 13 is a processing portion recording a television program, video shot by a camera, etc.

The storage portion 14 is a storage device such as a memory (e.g., an internal memory and a removable recording medium such as an SD (Secure Digital) card) and a hard disc device. The storage portion 14 stores content data 14a, container conversion data 14b, and player data 14c.

The content data 14a is data of contents recorded by the recording processing portion 13, data of shot video contents, and data of contents received from external apparatuses such as a personal computer and a digital video recorder apparatus connected to the server apparatus 10. The container conversion data 14b is data storing information of formats before and after conversion of content data having a convertible container format.

The player data 14c is device information such as a type, a model, and a reproduction capability of the player apparatus 20 and information of the formats of content data reproducible by the player apparatus 20. Content data reproducible by the player apparatus 20 is generated by reference to this information. As a result, a user does not need to specify a usable format of the player apparatus 20 in each case and convenience is enhanced. If a plurality of player apparatuses is present, the information is stored in correlation with the player apparatuses.

A user may set the information included in the player data 14c via the input portion 11. Alternatively, the control portion 19 described later may acquire the information included in the player data 14c from the player apparatus 20 and store the acquired information as the player data 14c into the storage portion 14c before generating the content data reproducible by the player apparatus 20.

The content analyzing portion 15 is a processing portion for analyzing content data stored as the content data 14a in the storage portion 14 to determine a type of a container, a type and an encoding condition of a video codec, a type and an encoding condition of an audio codec, etc., of the content data.

The container converting portion 16 is a processing portion for converting the container format of the content data 14a. The container converting portion 16 includes a data separating portion 16a, a video stream data buffer 16b, an audio stream data buffer 16c, and a data multiplexing portion 16d.

The data separating portion 16a is a processing portion that, if the player apparatus 20 makes a reproduction request or a transfer request, reads the content data becoming reproducible by the player apparatus 20 through the container format conversion, from the content data 14a stored in the storage portion 14 and that separates video data and audio data from the read content data.

The video stream data buffer 16b is a buffer temporarily storing the video data separated from the content data 14a. The audio stream data buffer 16c is a buffer temporarily storing the audio data separated from the content data 14a.

The data multiplexing portion 16d is a processing portion that multiplexes the video data temporarily stored in the video stream data buffer 16b and the audio data temporarily stored in the audio stream data buffer 16c and that converts the container format to generate content data in a format reproducible by the player apparatus 20, without executing the decoding and encoding processes of the video and audio data.

The content transmitting portion 17 is a processing portion for transmitting to the player apparatus 20 a content data list and the content data for which a reproduction request is made or the content data for which a transfer request is made by a user operating the player apparatus 20. When transmitting the content data list to the player apparatus 20, the content transmitting portion 17 acquires information of the content data having a convertible container format from the control portion 19 described later, and generates a list including information of the content data after the container format conversion and information of the content data stored as the contain data 14a in the storage portion 14.

Although the player apparatus 20 received this list displays the received list, the content data unreproducible by the player apparatus 20 is not displayed on the list. The user operating the player apparatus 20 refers to the displayed list and makes a reproduction request or a transfer request for desired content data to the server apparatus 10.

As described above, since the content transmitting portion 17 transmits to the player apparatus 20 the list including the information of the content data originally stored as the content data 14a in the server apparatus 10 as well as the information of the content data having a convertible container format, the information of reproducible content data in the content data included in the list is displayed on the displaying device of the player apparatus 20 receiving the list, and the previously unreproducible content data becomes reproducible by the player apparatus 20.

Alternatively, the content transmitting portion 17 may acquire the information of content data reproducible by the player apparatus 20 from the control portion 19, generate a list of the content data reproducible by the player apparatus 20, and transmit the generated list to the player apparatus 20.

As a result, the content transmitting portion 17 can effectively notify a user of the content data reproducible by the player apparatus 20. The notified user can make a reproduction request of the content data, or a transfer request of the content data, reproducible by the player apparatus 20 to the server apparatus 10 without realizing a difference in format of content data.

Although FIG. 2 depicts a case that the only one player apparatus 20 is present, if a plurality of payer apparatuses is present, the content transmitting portion 17 generates respective lists of reproducible content data for the player apparatuses in accordance with the formats of content data reproducible by the player apparatuses and transmits the generated lists to the player apparatuses. This assures that the content data included on the lists can be reproduced by the payer apparatuses, thereby avoiding a situation in which content data acquired based on the list cannot be reproduced.

The network connecting portion 18 is a processing portion for connecting the server apparatus 10 and the player apparatus 20 via a network 30 to transmit and receive data. The network connecting portion 18 transmits/receives data to/from the player apparatus 20 based on standards such as IEEE 802.11 and Ethernet (registered trade mark) and specifications such as UPnP (Universal Plug and Play).

The control portion 19 is a control device such as an MPU (micro processing unit), for example, and is a processing portion for generally controlling the server apparatus 10. The control portion 19 is responsible for giving and receiving of data between the functional portions.

The control portion 19 uses the analysis result conducted by the content analyzing portion 15 and the container conversion object data 14b stored in the storage portion 14 to execute a process of extracting the content data having a convertible container format out of the content data stored as the content data 14a in the storage portion 14.

For example, it is assumed that the formats usable for recording contents by the server apparatus 10 include (MP4, H.264(HD), AAC), (MP4, H.264(CIF), AAC), (MP4, MPEG-4, AAC), and (MP4, H.264, AMR), and that “H.264(HD) or H.264(CIF)” and “AAC” are stored in the container conversion data 14b as information of types of a video codec and an audio codec, respectively, of content data having a convertible container format.

In this case, the control portion 19 refers to the container conversion object data 14b and the analysis result conducted by the content analyzing portion 15 to extract content data having the types of the video and audio codecs matching those stored in the container conversion data 14b, i.e., the content data in the formats (MP4, H.264(HD), AAC) and (MP4, H.264(CIF), AAC) as the content data having a convertible container format.

On the other hand, content data having the types of the video and audio codecs not matching those stored in the container conversion data 14b, i.e., the content data in the formats (MP4, MPEG-4, AAC) and (MP4, H.264, AMR) are considered as those having an inconvertible container format and are not extracted.

By using the extraction result by the control portion and the container conversion data 14b, the content transmitting portion 17 generates a list including the information of the content data after container format conversion and the information of the content data stored as the content data 14a in the storage unit 14. Even if the list includes information of content data unreproducible by the player apparatus 20, the unreproducible content data is not displayed on the list in the player apparatus 20, causing no problem.

Alternatively, if content data stored as the content data 14a in the storage portion 14 has a format different from those of the content data reproducible by the player apparatus 20, the control portion 19 may execute a process of extracting the content data becoming reproducible by the player apparatus 20 if a container format is converted. This enables the content transmitting portion 17 to transmit a list including only the content data reproducible by the player apparatus 20 to the player apparatus 20.

In this case, the control portion 19 acquires the analysis result of the content data 14a conducted by the content analyzing portion 15 and reads the information of formats of content data reproducible by the player apparatus 20 from the player data 14c stored in the storage portion 14.

The control portion 19 determines whether content data reproducible by the player apparatus 20 can be generated by converting a container format, from the information of the analysis result of the content data 14a and the information of the format of content data reproducible by the player apparatus 20, and extracts the content data from which the reproducible content data can be generated. The control portion 19 also extracts the content data reproducible by the player apparatus 20 without the container format conversion. The control portion 19 does not extract the content data still unreproducible by the player apparatus 20 even if a container format is converted.

The control portion 19 may read information of a type, a model, and a reproduction capability of the player apparatus 20 from the player data 14c stored in the storage portion 14 and may use the read information to extract the content data. In this case, for example, the control portion 19 extracts the content data reproducible by the player apparatus 20 without the container format conversion and the content data becoming reproducible by the player apparatus 20 if a container format is converted.

However, when the type of the player apparatus 20 is a portable telephone, or when the model of the player apparatus 20 is a model with a lower image processing capability, or when the screen resolution of the player apparatus 20 is lower than a predetermined criterion, the control portion 19 does not extract content data requiring an image processing capability or resolution higher than a predetermined criterion from the player apparatus 20 at the time of reproduction because it is considered that the content data cannot be reproduced by the player apparatus 20. Whether or not the content data requires a higher image processing capability or higher resolution from the player apparatus 20 at the time of reproduction is determined by the content analyzing portion 15 by analyzing video data and audio data included in the content data.

Based on the extraction result from the control portion 19, the content transmitting portion 17 creates a list of content data reproducible by the player apparatus 20. This list includes information of the content data reproducible by the player apparatus 20 without the container format conversion or the content data becoming reproducible by the player apparatus 20 through the container format conversion, and does not include information of content data unreproducible by the player apparatus 20 even if a container format is converted.

In this case, based on a result of acceptance of a content data reproduction request or a content data transfer request from the player apparatus 20 and the extraction result of the control portion 19, the data separating portion 16a described above executes a process of reading the content data becoming reproducible by the player apparatus 20 through the container format conversion, from the content data 14a stored in the storage portion 14.

Although the control portion 19 determines whether the content data reproducible by the player apparatus 20 can be generated in this example, the container converting portion 16 may be provided with a processing portion making the determination so as to make the determination.

If a content data reproduction request or a content data transfer request is accepted from the player apparatus 20, the control portion 19 controls the storage portion 14, the content transmitting portion 17, and the network connecting portion 18 to transfer the content data to the player apparatus 20. If the container format of the content data must be converted, the control portion 19 controls and drives the container converting portion 16 to perform the container format conversion.

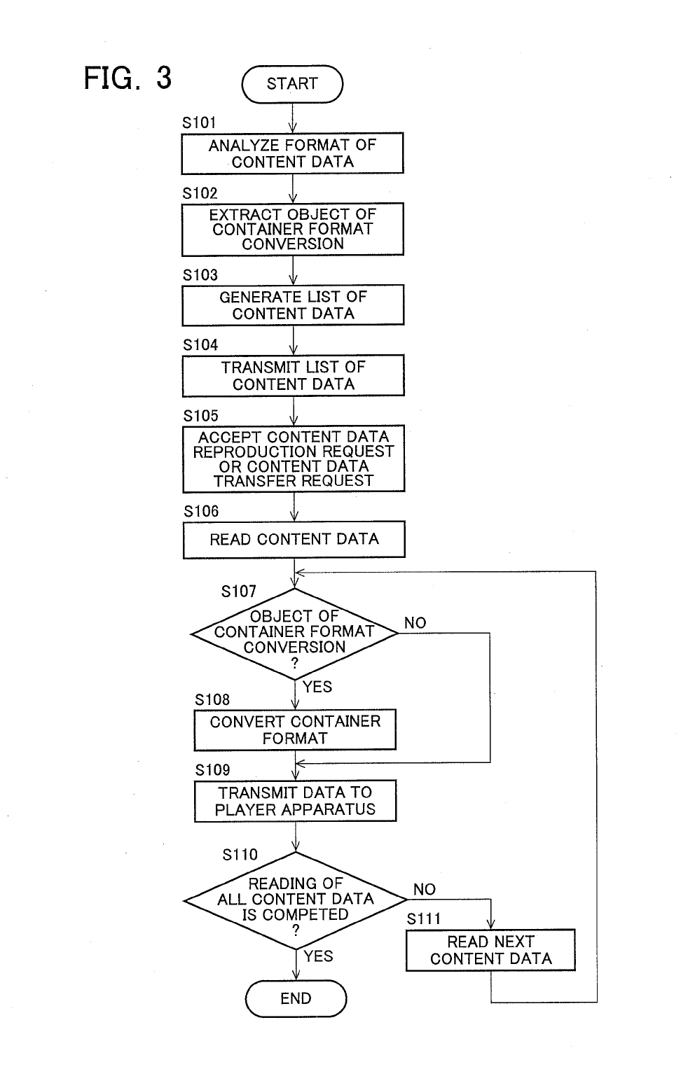

An example of a process procedure of the content data generating process according to the first embodiment will be described. FIG. 3 is a flowchart of an example of the process procedure of the content data generating process according to the first embodiment.

As depicted in FIG. 3, the content analyzing portion 15 of the server apparatus 10 analyzes the content data 14a stored in the storage portion 14 to determine a type of a container, a type and an encoding condition of a video codec, a type and an encoding condition of an audio codec, etc., of the content data 14a (step S101).

The control portion 19 uses the analysis result from the content analyzing portion 15 and the container conversion data 14b stored in the storage portion 14 to execute the process of extracting the content data having a convertible container format out of the content data stored as the content data 14a in the storage portion 14. Alternatively, the control portion 19 uses the analysis result of the content data 14a conducted by the content analyzing portion 15 and the information stored as the player data 14c in the storage portion 14 to execute the process of extracting the content data reproducible by the player apparatus 20 or the content data becoming reproducible by the player apparatus 20 through the container format conversion (step S102).

The content transmitting portion 17 uses the extraction result conducted by the control portion 19 to generate a list of content data including the information of the content data stored as the content data 14a in the storage portion 14 and information of content data after container format conversion (step S103). Alternatively, the content transmitting portion 17 uses the extraction result conducted by the control portion 19 to generate a list including the information of the content data reproducible by the player apparatus 20 or the information of the content data becoming reproducible by the player apparatus 20 through the container format conversion (step S103).

The content transmitting portion 17 then transmits the list of content data via the network connecting portion 18 to the player apparatus 20 (step S104). The content transmitting portion 17 accepts a content data reproduction request or a content data transfer request from the player apparatus 20 via the network connecting portion 18 (step S105).

The control portion 19 reads from the storage portion 14 one of the content data for which the reproduction request or the transfer request is accepted (step S106). The control portion 19 checks whether the read content data is an object of the container format conversion (step S107).

If the content data is not an object of the container format conversion (NO at step S107), the content transmitting portion 17 transmits the content data via the network connecting portion 18 to the player apparatus 20 (step S109).

If the content data is an object of the container format conversion (YES at step S107), the container converting portion 16 executes the container format conversion process of the content data (step S108). The content transmitting portion 17 then transmits the content data subjected to the container format conversion process via the network connecting portion 18 to the player apparatus 20 (step S109).

After the process of step S108, the control portion 19 checks whether the player apparatus 20 completes the reading of all the content data for which the reproduction or transfer request is accepted (step S110). If the reading of all the content data is not completed (NO at step S110), the control portion 19 reads the next content data (step S111). The procedure then goes to step S107 and the subsequent process is continued.

If the reading of all the content data is completed at step S110 (YES at step S110), the content data generating process is directly terminated.

In the example of FIG. 1, the content data format conversion is not performed for content data from which content data reproducible by the player apparatus 20 cannot be generated even if the container format is converted. However, as in the following description, transcoding may be performed for such content data to generate the content data reproducible by the player apparatus 20.

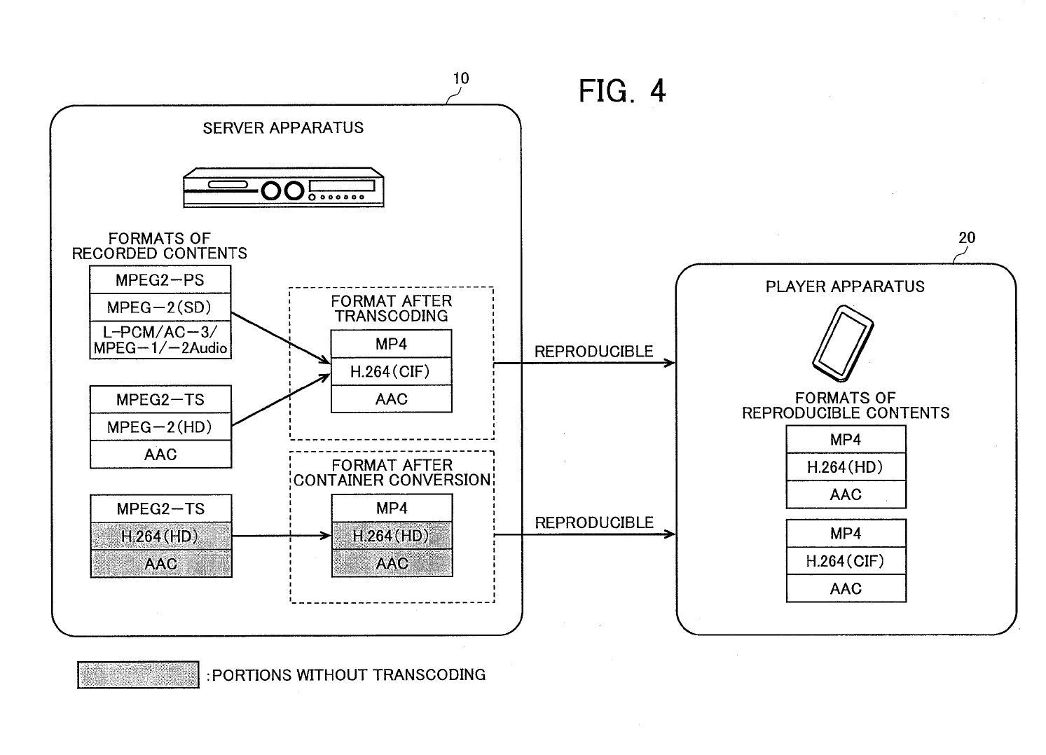

FIG. 4 is a diagram for explaining container format conversion or transcoding performed depending on a format of content data. In an example of FIG. 4, formats usable for recording and reproducing contents by the server apparatus 10 include (MPEG2-PS, MPEG-2(SD), L-PCM/AC-3/MPEG-1/-2 Audio), (MPEG2-TS, MPEG-2(HD), AAC), and (MPEG2-TS, H.264(HD), AAC).

Formats usable for reproducing contents by the player apparatus 20 include (MP4, H.264 (HD), AAC) and (MP4, H.264 (CIF), AAC).

With regard to the format (MPEG2-TS, H.264(HD), AAC) of recorded contents, the server apparatus 10 can generate content data reproducible by the player apparatus 20 by converting the container format from “MPEG2-TS” to “MP4”.

However, in the case of the formats (MPEG2-PS, MPEG-2(SD), L-PCM/AC-3/MPEG-1/-2 Audio) and (MPEG2-TS, MPEG-2(HD), AAC) of recorded contents, the server apparatus 10 cannot generate content data reproducible by the player apparatus 20 by simply converting the container formats.

Therefore, in this case, the server apparatus 10 performs the transcoding for the recorded contents in the formats of (MPEG2-PS, MPEG-2(SD), L-PCM/AC-3/MPEG-1/-2 Audio) and (MPEG2-TS, MPEG-2(HD), AAC) to generate content data in the format (MP4, H.264(HD), AAC) reproducible by the player apparatus 20. As a result, the content data reproducible by the player apparatus 20 can be generated from content data unable to be made reproducible by simply converting a container format.

Whether a certain format is subjected to the container format conversion or the transcoding is determined by the control portion 19 judging whether content data reproducible by the player apparatus 20 can be generated by only converting a container format. If the control portion 19 determines that the transcoding is performed, a transcoding executing portion not depicted performs the transcoding and transfers the transcoded content data to the content transmitting portion 17. The content transmitting portion 17 that received the content data transmits the received content data to the player apparatus 20.

Alternatively, the control portion 19 may perform the container format conversion or the transcoding based on an instruction given from a user. The control portion 19 may determine which process is executed, based on information of the player apparatus 20 such as a type, a model, and a reproduction capability. For example, if the resolution of the displaying device of the player apparatus 20 is lower than a predetermined criterion, the control portion 19 may perform the transcoding, which hardly maintains image quality, and if the resolution of the displaying device is higher than the predetermined criterion, the control portion 19 may perform the container format conversion, which maintains image quality.

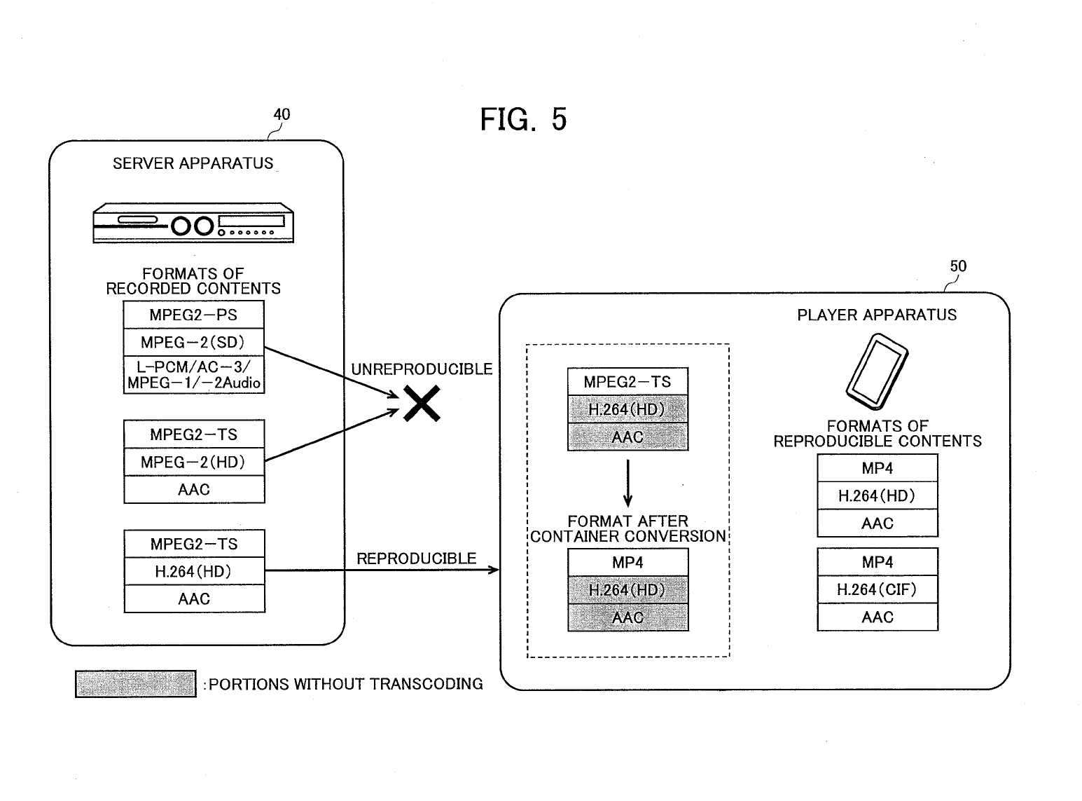

Although the server apparatus 10 performs the container format conversion in the embodiment, the player apparatus 20 may perform the container format conversion. FIG. 5 is a diagram for explaining an example of a container format conversion process executed by a player apparatus 50.

In the example of FIG. 5, formats usable for recording contents by a server apparatus 40 include (MPEG2-PS, MPEG-2(SD), L-PCM/AC-3/MPEG-1/-2 Audio), (MPEG2-TS, MPEG-2(HD), AAC), and (MPEG2-TS, H.264(HD), AAC).

Formats usable for reproducing contents by the player apparatus 50 include (MP4, H.264 (HD), AAC) and (MP4, H.264 (CIF), AAC).

The server apparatus 40 transmits to the player apparatus 50 the content data in the format (MPEG2-TS, H.264 (HD), AAC) becoming reproducible through the container format conversion by the player apparatus 50. The player apparatus 50 that received the content data converts the container format from “MPEG2-TS” to “MP4” without executing the decoding and encoding processes of the video and audio data. As a result, the player apparatus 50 can generate the reproducible content data in the format of (MP4, H.264(HD), AAC).

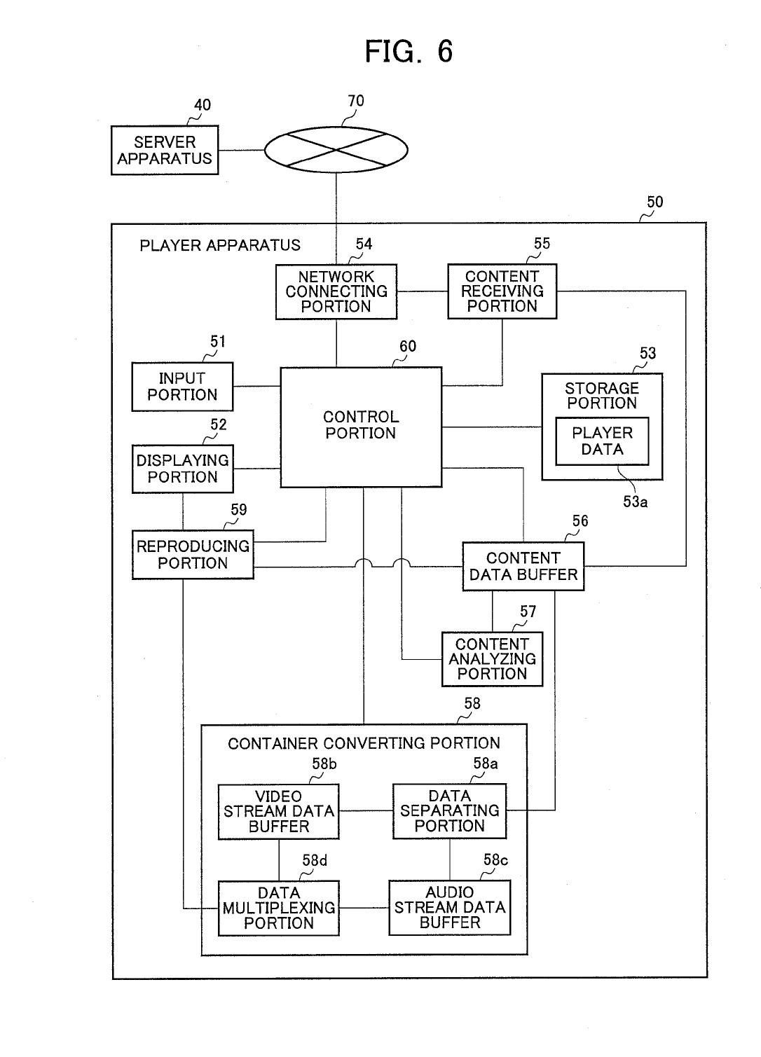

FIG. 6 is a functional block diagram of the player apparatus 50 performing the container format conversion. The player apparatus 50 is an apparatus that generates content data with a container format converted for the player apparatus 50 using container format information. As depicted in FIG. 6, the player apparatus 50 includes an input portion 51, a displaying portion 52, a storage portion 53, a network connecting portion 54, a content receiving portion 55, a content data buffer 56, a content analyzing portion 57, a container converting portion 58, a reproducing portion 59, and a control portion 60.

The input portion 51 is an input device such as operation buttons accepting input from a user. The displaying portion 52 is a displaying device such as a liquid-crystal display. The storage portion 53 is a storage device such as a memory (e.g., an internal memory and a removable recording medium such as an SD (Secure Digital) card) and a hard disc device. The storage portion 53 stores player data 53a. The player data 53a is device information such as a type, a model, and a reproduction capability of the player apparatus 50 and information of the formats of content data reproducible by the player apparatus 50.

The network connecting portion 54 is a processing portion for connecting the player apparatus 50 and the server apparatus 40 via a network 70 to transmit and receive data. The content receiving portion 55 is a processing portion for receiving from the server apparatus 40 a list of content data including meta-information of each content data and content data that is data of content itself. The meta-information is information acquired by analyzing content data with the content analyzing portion in the server apparatus 40. The meta-information includes a type of a container format, a type and an encoding condition of a video codec, a type and an encoding condition of an audio codec, etc., of each content data. The content data buffer 56 is a buffer temporarily storing content data received by the content receiving portion 55.

The content analyzing portion 57 is a processing portion for analyzing content data stored in the content data buffer 56 to detect meta-information such as a type of a container, a type and an encoding condition of a video codec, a type and an encoding condition of an audio codec, etc., of the content data. As a result, even if sufficient meta-information is not included in the list of content data received by the content receiving portion 55 from the server apparatus 40, the content analyzing portion 57 can acquire the meta-information for each content data.

The container converting portion 58 is a processing portion for converting the container format of the content data stored in the content data buffer 56. The container converting portion 58 includes a data separating portion 58a, a video stream data buffer 58b, an audio stream data buffer 58c, and a data multiplexing portion 58d.

The data separating portion 58a is a processing portion for reading the content data from the content data buffer 56, which becomes reproducible by the player apparatus 50 through the container format conversion, so as to separate video data and audio data from the read content data. The video stream data buffer 58b is a buffer temporarily storing the video data separated from the content data. The audio stream data buffer 58c is a buffer temporarily storing the audio data separated from the content data.

The data multiplexing portion 58d is a processing portion for multiplexing the video data and the audio data and converting a container format to generate content data in a format reproducible by the player apparatus 50, without executing the decoding and encoding processes of the video and audio data.

The reproducing portion 59 is a processing portion for reproducing the content data to display video acquired as a result of the reproduction on the displaying portion 52. The reproducing portion 59 reproduces the content data having a container format converted by the container converting portion 58. The reproducing portion 59 reads the content data reproducible by the player apparatus 50 without the container format conversion from the content data buffer 56 to reproduce the read content data.

The control portion 60 is a control device such as an MPU, for example. The control portion 60 is a processing portion for generally controlling the player apparatus 50 and responsible for giving and receiving of data between the functional portions.

The control portion 60 reads the information of formats of content data reproducible by the player apparatus 50 from the player data 53a stored in the storage portion 53 and determines whether the information of formats included in meta-information of the content list transmitted from the server apparatus 40 matches the information of formats of content data reproducible by the player apparatus 50. The control portion 60 causes the displaying portion 52 to display a list of content data including only the content data reproducible by the player apparatus 50.

If the format of content data reproducible by the player apparatus 50 read from the player data 53a matches the format of content data after the container format conversion when a container format is converted for content data included in the list of content data, the control portion 60 includes the content data into the list of reproducible content data to be displayed by the displaying portion 52.

The control portion 60 may read information of a type, a model, a reproduction capability, etc., of the player apparatus 50 from the player data 53a stored in the storage portion 53 and uses the read information to extract the content data to be displayed by the displaying portion 52. In this case, for example, the control portion 60 extracts the content data reproducible by the player apparatus 60 without the container format conversion and the content data becoming reproducible by the player apparatus 60 if a container format is converted.

However, when the type of the player apparatus 50 is a portable telephone, or when the model of the player apparatus 50 is a model with a lower image processing capability, or when the screen resolution of the displaying portion 52 is lower than a predetermined criterion, the control portion 60 does not extract the content data requiring an image processing capability or resolution higher than a predetermined criterion from the player apparatus 50 at the time of reproduction because it is considered that the content data cannot be reproduced by the player apparatus 50. The control portion 60 determines whether or not the content data requires a higher image processing capability or higher resolution from the player apparatus 50 at the time of reproduction, by receiving information of size and resolution of the content data from the serve apparatus 40, for example.

Alternatively, the control portion 60 may read the information of the format of the content data reproducible by the player apparatus 50 from the player data 53a stored in the storage portion 53 to request the server apparatus 40 to transmit content data in a format matching the format. In this case, after reading from the player data 53a, the control portion 60 also requests the server apparatus 40 to transmit content data becoming reproducible by the player apparatus 50 if a container format is converted. If the requested content data is present, the server apparatus 40 transmits a list including the content data to the player apparatus 50 and the control portion 60 of the player apparatus 50 receiving the list causes the displaying portion 52 to display the received list as the list of reproducible content data.

If a user selects content data from the list of content data, the control portion 60 transmits the selection result to the server apparatus 40. If content data is transmitted from the server apparatus 40 in accordance with the selection result and the content data stored in the content data buffer 56 has a format different from those of the content data reproducible by the player apparatus 50, the control portion 60 extracts the content data becoming reproducible by the player apparatus 50 if a container format is converted.

Specifically, the control portion 60 acquires the analysis result of content data from the content analyzing portion 57 and reads the information of formats of content data reproducible by the player apparatus 50 from the player data 53a stored in the storage portion 53.

The control portion 60 determines whether content data reproducible by the player apparatus 50 can be generated by converting a container format, from the information of the analysis result of the content data and the information of the formats of content data reproducible by the player apparatus 50, and extracts the content data from which the reproducible content data can be generated. The control portion 60 also extracts the content data reproducible by the player apparatus 50 without the container format conversion.

Based on the extraction result conducted by the control portion 60, the data separating portion 58a reads the content data becoming reproducible by the player apparatus 50 through the container format conversion from the content data buffer 56. The reproducing portion 59 reads the content data reproducible by the player apparatus 50 without the container format conversion from the content data buffer 56 based on the extraction result conducted by the control portion 60.

As described above, by converting a container format in the player apparatus 50, the content data previously unreproducible by the player apparatus 10 becomes reproducible as in the case of converting the container format in the server apparatus 10 depicted in FIG. 3. The player apparatus 50 can easily select a format of content data suitable for the reproduction capability of the player apparatus 50. In this case, it is not necessary to change the server apparatus 40 and, therefore, a conventional server apparatus can directly be used for the server apparatus 40.

Although ARIB (Association of Radio Industries and Businesses) TR-B14 has a copyright protection mechanism defined for broadcast contents having content data transmitted in the container format “MPEG-2 TS”, since it is not necessary to change the server apparatus 40, the copyright protection mechanism can directly be utilized for transferring content data to the player apparatus 50.

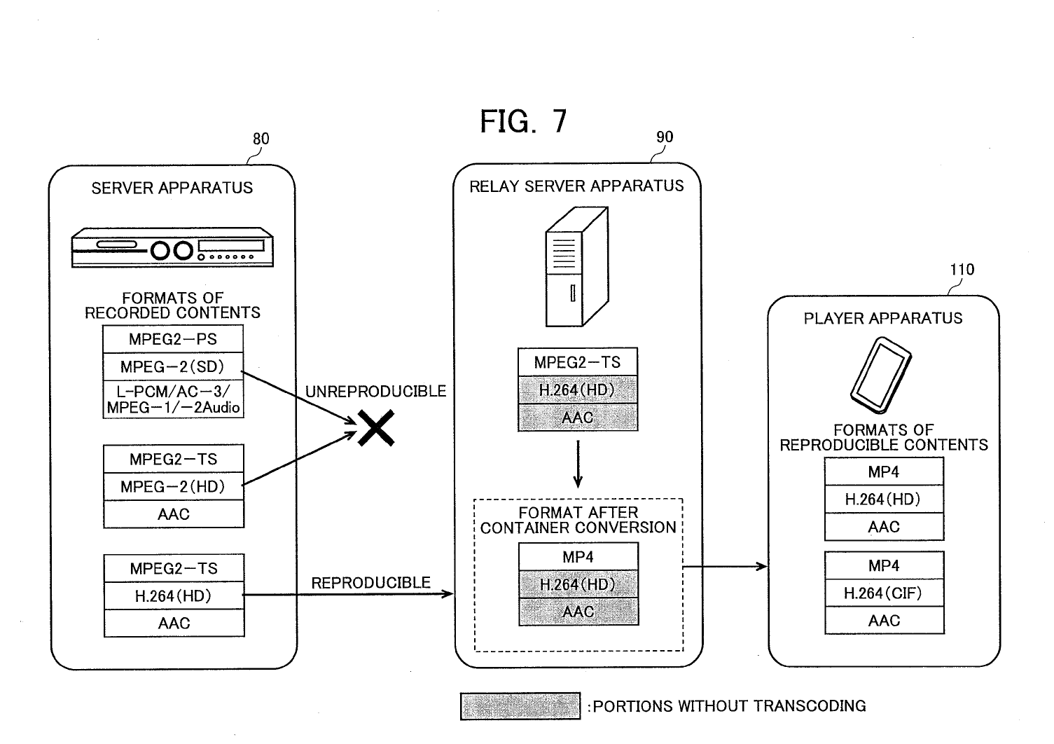

Although the server apparatus or the player apparatus performs the container format conversion in the embodiment, a relay server apparatus interposed between the server apparatus or the player apparatus may perform the container format conversion. FIG. 7 is a diagram for explaining an example of a container format conversion process executed by a relay server apparatus 50.

In the example of FIG. 7, formats usable for recording contents by a server apparatus 80 include (MPEG2-PS, MPEG-2(SD), L-PCM/AC-3/MPEG-1/-2 Audio), (MPEG2-TS, MPEG-2(HD), AAC), and (MPEG2-TS, H.264(HD), AAC).

Formats usable for reproducing contents by a player apparatus 110 include (MP4, H.264(HD), AAC) and (MP4, H.264 (CIF), AAC).

The server apparatus 80 transmits to the relay server apparatus 90 the content data in the format (MPEG2-TS, H.264 (HD), AAC) becoming reproducible if the player apparatus 110 performs the container format conversion. The relay server apparatus 90 that received the content data converts the container format from “MPEG2-TS” to “MP4” without executing the decoding and encoding processes of the video and audio data. The relay server apparatus 90 transmits the content data in the format (MP4, H.264(HD), AAC) acquired by the container format conversion to the player apparatus 110. As a result, the player apparatus 110 can acquire the reproducible content data.

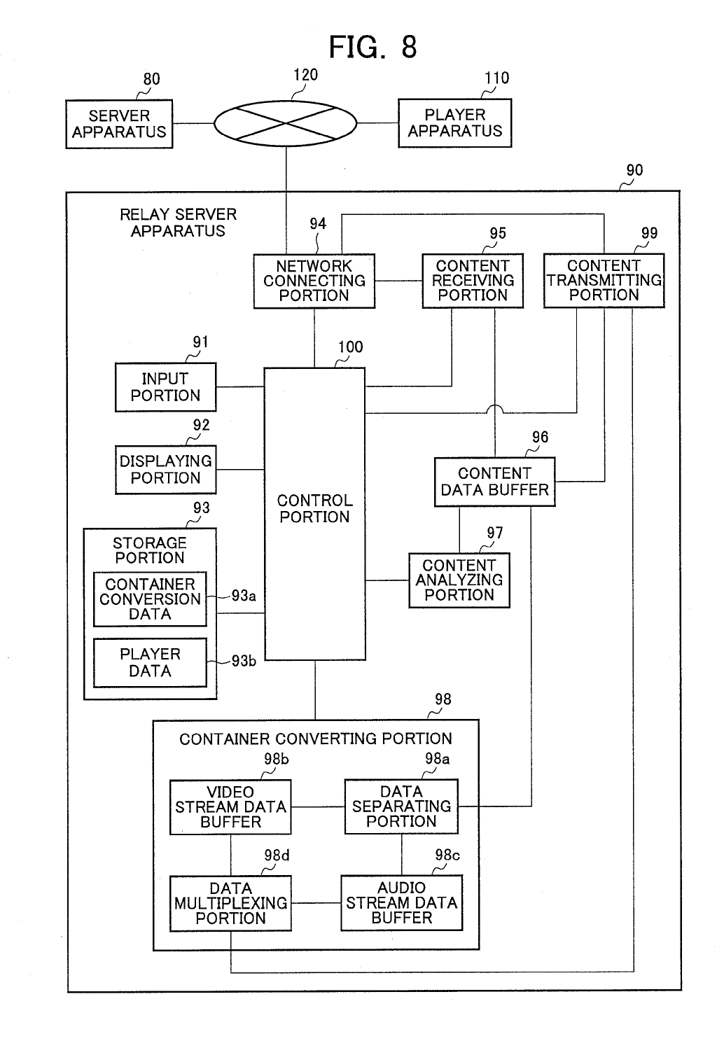

FIG. 8 is a functional block diagram of the relay server apparatus 90 performing the container format conversion. The relay server apparatus 90 is an apparatus that generates content data with a container format converted for the player apparatus 110 using container format information. As depicted in FIG. 8, the relay server apparatus 90 includes an input portion 91, a displaying portion 92, a storage portion 93, a network connecting portion 94, a content receiving portion 95, a content data buffer 96, a content analyzing portion 97, a container converting portion 98, a content transmitting portion 99, and a control portion 100.

The input portion 91 is an input device such as operation buttons accepting input from a user. The displaying portion 92 is a displaying device such as a liquid-crystal display. The storage portion 93 is a storage device such as a memory (e.g., an internal memory and a removable recording medium such as an SD (Secure Digital) card) and a hard disc device. The storage portion 93 stores container conversion data 93a and player data 93b. The container conversion data 93a is data stored as information of formats before and after conversion of content data having a convertible container format. The player data 93b is device information such as a type, a model, and a reproduction capability of the player apparatus 110 and information of the formats of content data reproducible by the player apparatus 110.

The network connecting portion 94 is a processing portion for connecting the relay server apparatus 90 to the server apparatus 80 or the player apparatus 110 via a network 120 to transmit and receive data. The content receiving portion 95 is a processing portion for receiving from the server apparatus 80 a list of content data including meta-information of each content data and content data that is data of content itself. The content data buffer 96 is a buffer temporarily storing content data received by the content receiving portion 95.

The content analyzing portion 97 is a processing portion for analyzing content data stored in the content data buffer 96 to detect meta-information such as a type of a container, a type and an encoding condition of a video codec, a type and an encoding condition of an audio codec, etc., of the content data. As a result, even if sufficient meta-information is not included in the list of content data received by the content receiving portion 95 from the server apparatus 80, the content analyzing portion 97 can acquire meta-information for each content data.

The container converting portion 98 is a processing portion for converting a container format of the content data stored in the content data buffer 96. The container converting portion 98 includes a data separating portion 98a, a video stream data buffer 98b, an audio stream data buffer 98c, and a data multiplexing portion 98d.

The data separating portion 98a is a processing portion for reading the content data from the content data buffer 96, which becomes reproducible by the player apparatus 110 through the container format conversion, so as to separate video data and audio data from the read content data.

The video stream data buffer 98b is a buffer temporarily storing the video data separated from the content data. The audio stream data buffer 98c is a buffer temporarily storing the audio data separated from the content data.

The data multiplexing portion 98d is a processing portion for multiplexing the video data and the audio data and converting a container format to generate content data in a format reproducible by the player apparatus 110, without executing the decoding and encoding processes of the video and audio data.

The content transmitting portion 99 is a processing portion for transmitting to the player apparatus 110 via the network connecting portion 94 a content data list and content data for which a reproduction request is made or content data for which a transfer request is made by a user operating the player apparatus 110. If the content receiving portion 95 receives a list of content data stored in the server apparatus 80, the content transmitting portion 99 transmits the list to the player apparatus 110.

In this case, the content transmitting portion 99 acquires information of the content data having a convertible container format from a control portion 100 described later, and generates a list acquired by adding information of content data after container format conversion to the received list, and transmits the list to the player apparatus 110. Although the player apparatus 110 receiving this list executes a process of displaying the received list, the content data unreproducible by the player apparatus 110 is not displayed on the list. The user who operates the player apparatus 110 refers to the displayed list and makes a reproduction request or a transfer request for desired content data to the server apparatus 80.

The control portion 100 is a control device such as an MPU, for example. The control portion 100 is a processing portion for generally controlling the player apparatus 90 and responsible for giving and receiving of data between the functional portions etc.

The control portion 100 uses the information of formats included in meta-information of the content data list transmitted from the server apparatus 80 and the container conversion data 93a stored in the storage portion 93 to execute a process of extracting the content data having a convertible container format out of the content data included in the list transmitted from the server apparatus 80.

For example, it is assumed that the formats usable for recording contents by the server apparatus 80 include (MPEG2-PS, MPEG-2(SD), L-PCM/AC-3/MPEG-1/-2 Audio), (MPEG2-TS, MPEG-2(HD), AAC), and (MPEG2-TS, H.264(HD), AAC), and that “H.264(HD)” and “AAC” are stored in the container conversion data 93a as information of types of a video codec and an audio codec, respectively, of content data having a convertible container format.

In this case, the control portion 100 refers to the container conversion data 93a to extract content data having the types of the video and audio codecs matching those stored in the container conversion data 93a, i.e., the content data in the format (MPEG2-TS, H.264(HD), AAC) as the content data having a convertible container format.

On the other hand, content data having the types of the video and audio codecs not matching those stored in the container conversion data 93a, i.e., the content data in the formats (MPEG2-PS, MPEG-2(SD), L-PCM/AC-3/MPEG-1/-2 Audio) and (MPEG2-TS, MPEG-2(HD), AAC) are considered as those having an inconvertible container format and are not extracted.

Based on the extraction result conducted by the control portion 100, the content transmitting portion 99 generates a list acquired by adding the information of content data after container format conversion to the content data list received from the server apparatus 80. Even if the list includes information of content data unreproducible by the player apparatus 110, the unreproducible content data is not displayed on the list in the player apparatus 110, causing no problem.

Alternatively, if a format of content data included in the list is different from those of the content data reproducible by the player apparatus 110, the control portion 100 may execute a process of extracting content data becoming reproducible by the player apparatus 110 if a container format is converted, out of the list.

Specifically, the control portion 100 acquires the meta-information of the content data list acquired from the server apparatus 80 and reads the information of formats of content data reproducible by the player apparatus 110 from the player data 93b stored in the storage portion 93.

The control portion 100 determines whether content data reproducible by the player apparatus 110 can be generated by converting a container format, from the meta-information of the content data list and the information of the format of content data reproducible by the player apparatus 110, and extracts the content data from which the reproducible content data can be generated. The control portion 100 also extracts the content data reproducible by the player apparatus 110 without the container format conversion.

The control portion 100 may read information of a type, a model, and a reproduction capability of the player apparatus 110 from the player data 93b stored in the storage portion 93 and may use the read information to extract the content data. In this case, for example, the control portion 100 extracts the content data reproducible by the player apparatus 110 without the container format conversion and the content data becoming reproducible by the player apparatus 110 if a container format is converted.

However, when the type of the player apparatus 110 is a portable telephone, or when the model of the player apparatus 110 is a model with a lower image processing capability, or when the screen resolution of the player apparatus 110 is lower than a predetermined criterion, the control portion 100 does not extract content data requiring an image processing capability or resolution higher than a predetermined criterion from the player apparatus 110 at the time of reproduction because it is considered that the content data cannot be reproduced by the player apparatus 110. The control portion 100 determines whether or not the content data requires a higher image processing capability or higher resolution conducted by the player apparatus 110 at the time of reproduction, by receiving the information on size and resolution of the content data from the server apparatus 80, for example.

The content transmitting portion 99 generates a list acquired by deleting the content data not extracted by the control portion 100 out of the content data list transmitted by the server apparatus 80 and transmits the generated list to the player apparatus 110. Based on the extraction result conducted by the control portion 100, the data separating portion 98a executes a process of reading the content data becoming reproducible by the player apparatus 110 through the container format conversion, from the content data buffer 96.

If a content data reproduction request or a content data transfer request is accepted from the player apparatus 110, the control portion 100 controls the content data buffer 96, the content transmitting portion 99, and the network connecting portion 94 to transfer the content data to the player apparatus 110.

If the container format of the content data must be converted, the control portion 100 controls and drives the container converting portion 98 to perform the container format conversion. Specifically, if a content data reproduction request or a content data transfer request is accepted, the control portion 100 reads the format information corresponding to the content data from the container conversion data 93a or the player data 93b and uses the read information to convert the container format into a container format reproducible by the player apparatus 110.

As described above, by performing the container conversion in the relay server apparatus 90, the content data previously unreproducible by the player apparatus 110 becomes reproducible as in the case of performing the container conversion in the server apparatus 10 depicted in FIG. 3. In this case, it is not necessary to change the server apparatus 80 and the player apparatus 110 and, therefore, conventional server and player apparatuses can directly be used for the server apparatus 80 and the player apparatus 110.

Since it is not necessary to change the server apparatus 80, the server apparatus 80 can directly utilize the copyright protection mechanism defined for broadcast contents by ARIB TR-B14 to transfer content data to the relay server apparatus 90.

As described above, the container format conversion is a process applying a less load to an apparatus and, therefore, the content data generating process can easily be implemented even in a portable terminal with an MPU having lower performance or lower image processing capability. Since the decoding processes of video and audio data and the encoding process of decoded video and audio data are not executed in the container format conversion, it is not necessary to handle uncompressed data and the content data generating process can be implemented with a small capacity memory.

Even if content data in the server apparatus is sequentially transferred through streaming and reproduced in the player apparatus as in a technique advocated by DLNA, the container format conversion process can be executed in real time. Therefore, even if content data usable in the server apparatus cannot directly be reproduced by the player apparatus, the content data with a container format converted can be reproduced by the player apparatus through streaming.

Since the server apparatus, the relay server apparatus, or the player apparatus preliminarily stores information of the format of content data reproducible by the player apparatus and generates content data based on the information, the player apparatus can easily be allowed to reproduce the content data by simply transmitting the generated content data to the player apparatus, or the player apparatus can easily reproduce the content data by itself.

Since the server apparatus, the relay server apparatus, or the player apparatus preliminarily stores information of the format of content data reproducible by the player apparatus, a user has no need to remember the formats of content data reproducible by the player apparatus. Even if a user remembers the container format reproducible by the player apparatus, the user often does not know the video and audio codecs of contents data reproducible by the player apparatus since a wide variety of codecs exists; however, even in such a case, the user can be spared the trouble of generating content data by trial and error and checking whether the content data can be reproduced by the player apparatus.

### Second Embodiment

A second embodiment will be described in terms of a process of converting a codec of video data or a codec of audio data included in content data to generate content data reproducible by a player apparatus, without executing a decoding process of the video and audio data and an encoding process of the decoded video and audio data.

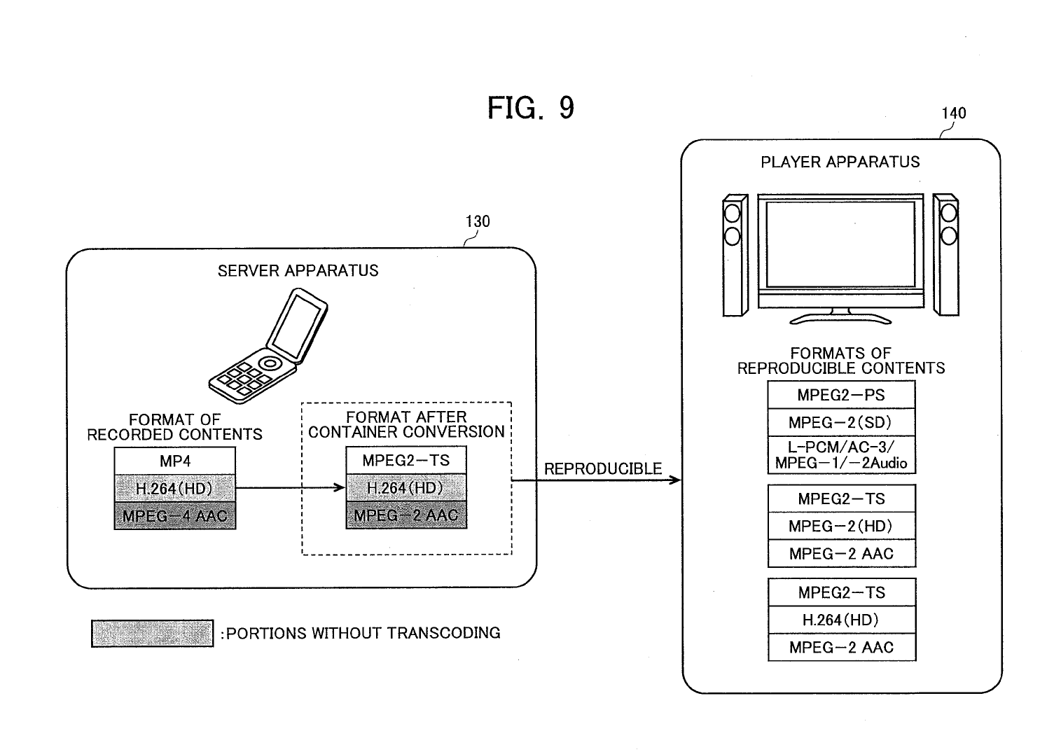

FIG. 9 is a diagram for explaining a content data generating process according to a second embodiment of the present invention. In the example of FIG. 9, formats usable for recording contents by a server apparatus 130 include (MP4, H.264(HD), MPEG-4 AAC).

Formats usable for reproducing contents by a player apparatus 140 include (MPEG2-PS, MPEG-2(SD), L-PCM/AC-3/MPEG-1/-2 Audio), (MPEG2-TS, MPEG-2(HD), MPEG-2 AAC), and (MPEG2-TS, H.264(HD), MPEG-2 AAC).

Although the audio codec “MPEG-4 AAC” is a codec acquired by expanding the functions of the audio codec “MPEG-2 AAC”, the expanded functions may not be utilized by a portable terminal with lower processing performance, for example.

In such a case, the server apparatus 130 rewrites a parameter (identifier) identifying “MPEG-4 AAC” and “MPEG-2 AAC” in an ADTS (Audio Transport Stream) header of audio data to convert the codec of the audio data from “MPEG-4 AAC” to “MPEG-2 AAC”.

The server apparatus 130 also converts a container format of recorded contents from “MP4” to “MPEG2-TS” without executing a decoding process of the video and audio data and an encoding process of the decoded video and audio data. As a result, the server apparatus 130 can generate content data reproducible by the player apparatus 140 in the format (MPEG2-TS, H.264(HD), MPEG-2 AAC).

A configuration of the server apparatus 130 according to the second embodiment will be described. Since the server apparatus 130 according to the second embodiment is almost the same as the server apparatus 10 depicted in FIG. 2 except the process executed by the container converting portion 16, differences from the server apparatus 10 of the first embodiment will hereinafter be described.

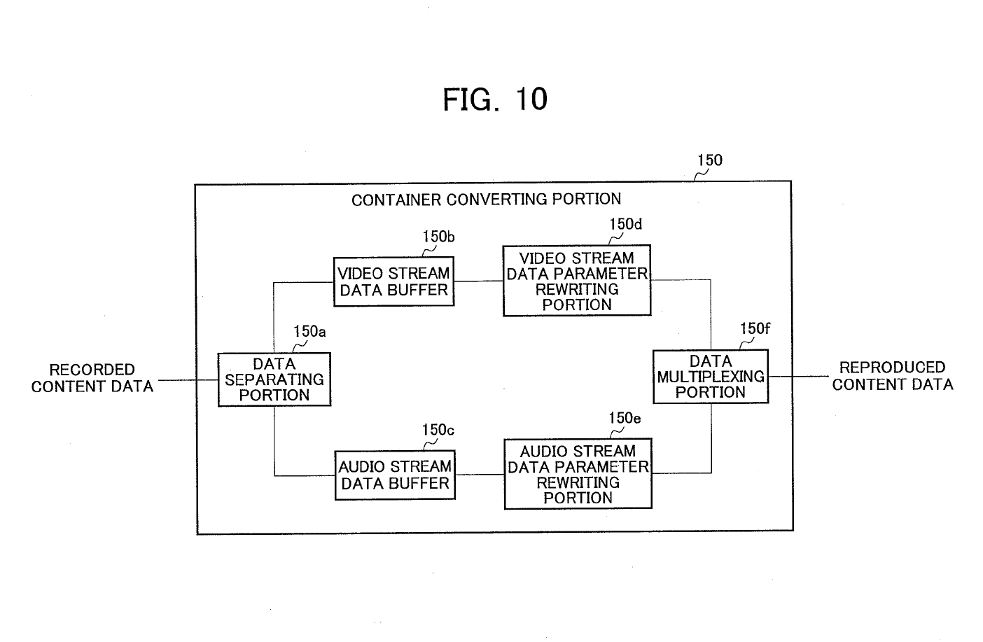

FIG. 10 is a functional block diagram of a container converting portion 150 in the server apparatus according to the second embodiment. The container converting portion 150 includes a data separating portion 150a, a video stream data buffer 150b, an audio stream data buffer 150c, a video stream data parameter rewriting portion 150d, an audio stream data parameter rewriting portion 150e, and a data multiplexing portion 150f.

The data separating portion 150a is a processing portion for separating video data and audio data from content data. Specifically, the data separating portion 150a separates video data and audio data from the content data becoming reproducible by the player apparatus 140 through the container format conversion or thorough rewriting of the parameter identifying the codecs of video and audio data included in the video and audio data in addition to the container format conversion.

Whether content data becomes reproducible through the container format conversion is determined by the method same as the first embodiment. For example, the determination will be made on whether content data becomes reproducible through rewriting of the parameters identifying the codecs of video and audio data in addition to the container format conversion as follows.

Specifically, the storage portion 14 of the first embodiment preliminarily stores information of a video codec or an audio codec becoming usable as a video codec or an audio codec identified by a rewritten parameter after rewriting a parameter identifying a video codec or an audio codec.

The control portion 19 of the first embodiment may then make the determination from the information of the video codec or the audio codec and the analysis result of the format of contents conducted by the content analyzing portion 97 or the information of the format of content data reproducible by the player apparatus 20 stored as the player data 14c in the storage portion 14.

The video stream data buffer 150b is a buffer temporarily storing the video data separated from the content data. The audio stream data buffer 150c is a buffer temporarily storing the audio data separated from the content data.

The video stream data parameter rewriting portion 150d is a processing portion that, if simply rewriting a parameter identifying a video codec can convert the video codec into a video codec of the video data reproducible by the player apparatus 140, rewrites the parameter so as to indicate the video codec of the video data reproducible by the player apparatus 140. If content data can be converted into the content data reproducible by the player apparatus 140 by only converting the container format, the video stream data parameter rewriting portion 150d may not rewrite the parameter.

The audio stream data parameter rewriting portion 150e is a processing portion that, if simply rewriting a parameter identifying an audio codec can convert the audio codec into an audio codec of the audio data reproducible by the player apparatus 140, rewrites the parameter so as to indicate the audio codec of the audio data reproducible by the player apparatus 140. If content data can be converted into the content data reproducible by the player apparatus 140 by only converting the container format, the audio stream data parameter rewriting portion 150e may not rewrite the parameter.

The data multiplexing portion 150f is a processing portion that multiplexes the video data having the parameter identifying the video codec rewritten by the video stream data parameter rewriting portion 150d and the audio data having the parameter identifying the audio codec rewritten by the audio stream data parameter rewriting portion 150e and that converts a container format to generate content data in a format reproducible by the player apparatus 140, without executing the decoding and encoding processes of the video and audio data.

Without making the determination of whether content data becomes reproducible through rewriting of the parameters identifying the codecs of video and audio data, if a parameter can be rewritten, the video stream data parameter rewriting portion 150d or the audio stream data parameter rewriting portion 150e may unconditionally rewrite the parameter. In this case, even if the content data is unreproducible by the player apparatus 140 after the rewriting of the parameter, the content data may be handled as the content data unreproducible by the player apparatus 140.

As described above, the codec of video data or the codec of audio data included in content data is converted without executing the decoding and encoding processes and, therefore, a range of reproducible content data can be expanded. Since it is not necessary to handle uncompressed data, the content data generating process can be implemented with a small capacity memory.

Since the codec can be converted by simply rewriting the parameter identifying the codec, a load applied to the apparatus can be reduced and the content data generating process can easily be implemented by a portable terminal with lower MPU performance or lower image processing capability.

### Third Embodiment

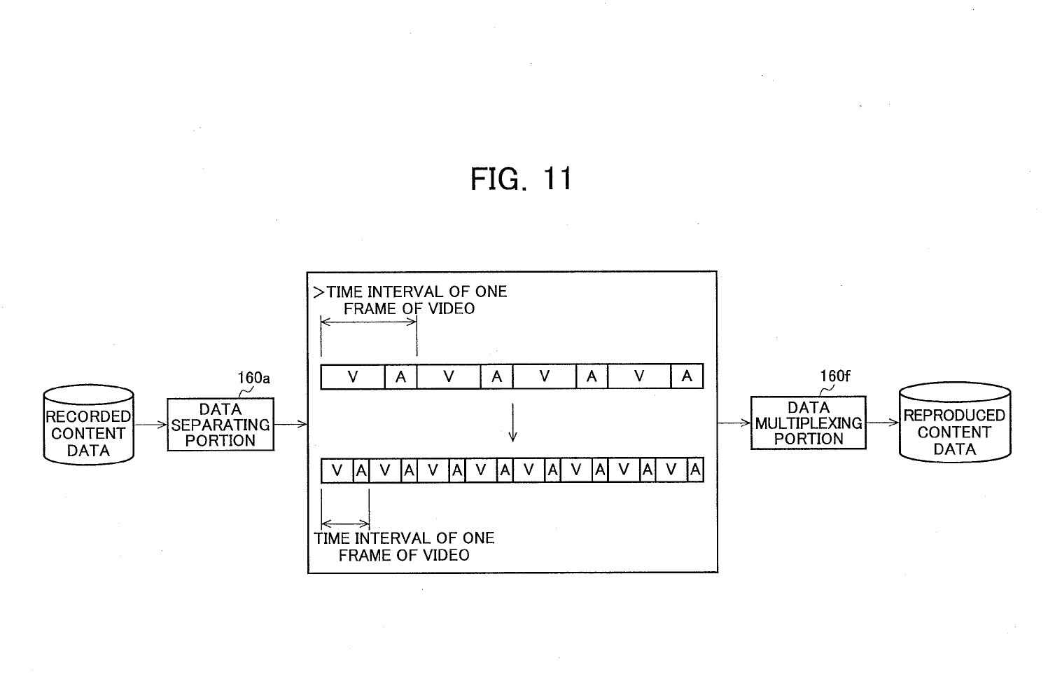

A third embodiment will be described in terms of the case that a time interval of alternate storage of video data and audio data in a container is changed to a time interval suitable for a reproduction process in a player apparatus in addition to the process of the first or second embodiment. FIG. 11 is a diagram for explaining a process of changing a time interval of alternate storage of video data and audio data in a container.

As depicted in FIG. 11, data of recorded contents is separated by a data separating portion 160a into video data and audio data, is subsequently subjected to the multiplexing process of the video data and the audio data and the container format conversion process by a data multiplexing portion 160b, and is output as reproduction content data.

The content data has, for example, a container such as a TS (Transport Stream) container, in which video data (data denoted by “V” of FIG. 11) and audio data (data denoted by “A” of FIG. 11) are alternately stored. In the case of broadcast contents, a shorter time interval is defined for alternately storing the video data and the audio data in the container; however, some contents for portable terminals have the time interval defined longer.

In such a case, if it is attempted to reproduce the contents for portable terminals by a player apparatus such as a television assumed to reproduce only the broadcast contents, a storage capacity may become insufficient in a buffer temporarily storing content data decoded by a decoder. If the storage capacity of the buffer becomes insufficient, buffer overflow occurs, making the reproduction of content data impossible.

To prevent this situation, if the time interval of alternate storage of video data and audio data in a container is longer than a predetermined time interval reproducible by a player apparatus, a server apparatus generates content data having the time interval set equal to or less than the predetermined time interval. In an example depicted in FIG. 11, when the time interval of alternate storage of video data and audio data is longer than a time width of one frame of video, the time interval is set to the time width of one frame. Such a process enables the player apparatus to reproduce the content data.

A configuration of the server apparatus according to the third embodiment will be described. Since the server apparatus according to the third embodiment is almost the same as the server apparatus 10 depicted in FIG. 2 except the process executed by the container converting portion 16, differences from the server apparatus 10 of the first embodiment will hereinafter be described.

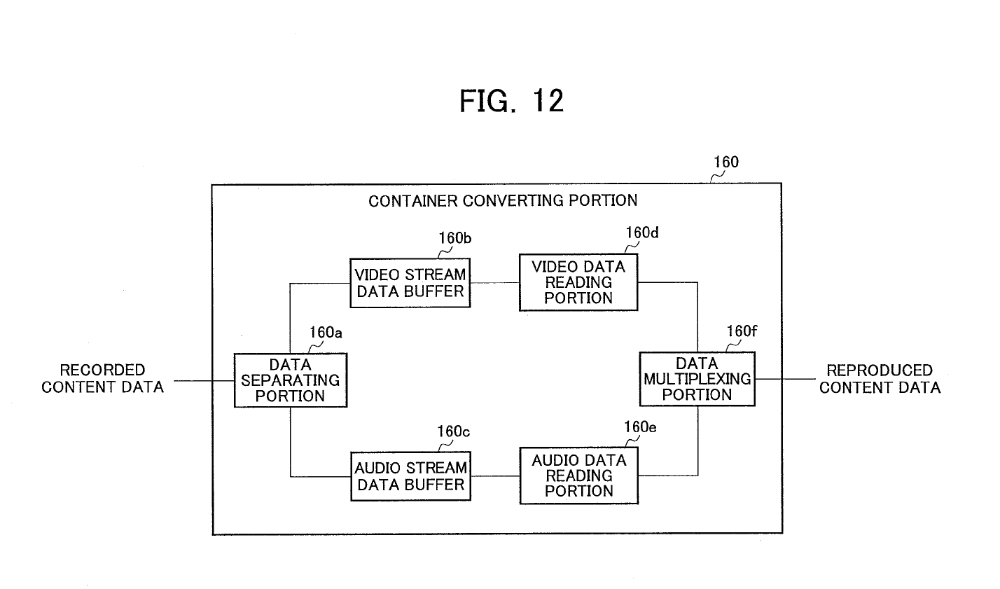

FIG. 12 is a functional block diagram of a container converting portion 160 in the server apparatus according to the third embodiment. The container converting portion 160 includes a data separating portion 160a, a video stream data buffer 160b, an audio stream data buffer 160c, a video data reading portion 160d, an audio data reading portion 160e, and a data multiplexing portion 160f.

The data separating portion 160a is a processing portion for separating video data and audio data from content data. The video stream data buffer 160b is a buffer temporarily storing the video data separated from the content data. The audio stream data buffer 160c is a buffer temporarily storing the audio data separated from the content data.

The video data reading portion 160d is a processing portion for reading the video data for one frame of video from the video stream data buffer 160b. The audio data reading portion 160e is a processing portion for reading the audio data for one frame of video from the audio stream data buffer 160c.

The data multiplexing portion 160f is a processing portion that multiplexes the video data for one frame of video read from the video data reading portion 160d and the audio data for one frame of video read from the audio data reading portion 160e in ascending order of time and that converts a container format, without executing the decoding and encoding processes of the video and audio data, to generate content data having the video data and the audio data alternately rearranged at predetermined time intervals reproducible by the player apparatus.

By generating the content data having the video data and the audio data alternately rearranged at time intervals reproducible by the player apparatus, for example, the player apparatus supporting only the multiplexing time interval for broadcast contents can reproduce the content data other than broadcast contents.

Since the process of rearranging the video data and the audio data does not apply a large load to the apparatus, the content data generating process can easily be implemented by a portable terminal with lower MPU performance or lower image processing capability.

Although the embodiments of the content data generating apparatus and the content data generating method has been mainly described, the present invention is not limited to these embodiments and may be implemented in a form of a computer program for realizing the function of the content data generating apparatus or a form of a computer-readable recording medium recording the computer program.

Various forms of recording medium can be employed such as a disc system (e.g., magnetic discs, optical discs), a card system (e.g., memory cards, optical cards), a semiconductor memory system (e.g., ROM, non-volatile memories), and a tape system (e.g., magnetic tapes, cassette tapes).

The computer program that realizes the function of the content data generating apparatus of the embodiments or the computer program that is run on a computer to execute the content data generating method can be recorded and distributed in these recording mediums to reduce cost and improve portability and versatility.

After mounting the recording medium on a computer and reading the computer program recorded in the recording medium to a memory by the computer, a processor (CPU: central processing unit, MPU: micro processing unit) included in the computer can read and execute the computer program from the memory to realize the function of the content data generating apparatus and perform the content data generating method according to the embodiments.

The present invention is not limited to the embodiments described above and may variously be altered or modified without departing from the spirit of the present invention.

### EXPLANATIONS OF LETTERS OR NUMERALS

10, 40, 80, 130 . . . server apparatus; 11, 51, 91 . . . input portion; 12, 52, 92 . . . displaying portion; 13 . . . recording processing portion; 14, 53, 93 . . . storage portion; 14a . . . content data; 14b, 93a . . . container conversion data; 14c, 53a, 93b . . . player data; 15, 57, 97 . . . content analyzing portion; 16, 58, 98, 150, 160 . . . container converting portion; 16a, 58a, 150a, 160a, 301 . . . data separating portion; 16b, 58b, 150b, 160b . . . video stream data buffer; 16c, 58c, 150c, 160c . . . audio stream data buffer; 16d, 58d, 150f, 160f, 309 . . . data multiplexing portion; 17, 99 . . . content transmitting portion; 18, 54, 94 . . . network connecting portion; 19, 60, 100 . . . control portion; 20, 50, 110, 140 . . . player apparatus; 30, 70, 120 . . . network; 55, 95 . . . content receiving portion; 56, 96 . . . content data buffer; 59 . . . reproducing portion; 90 . . . relay server apparatus; 150d . . . video stream data parameter rewriting portion; 150e . . . audio stream data parameter rewriting portion; 160d . . . video data reading portion; 160e . . . audio data reading portion; 200 . . . digital video recorder; 201 . . . digital television; 202, 203 . . . portable telephone; 300 . . . portable terminal content data; 302 . . . video data decoder; 303 . . . audio data decoder; 304, 305 . . . flame buffer; 306 . . . resizer; 307 . . . video data encoder; 308 . . . audio data decoder; and 400 . . . digital appliance content data.

1.-17. (canceled)

18. A device for generating content data generating content data reproducible by a player apparatus by using a container format usable by the player apparatus, comprising:
a storage portion that stores format information at least including information of the container format and encoded information of multimedia data included in the content data, and model information including information of at least a type, a model, or a reproduction capability of the player apparatus;
a control portion that extracts content data in a container format unusable by the player apparatus, the content data from which content data reproducible by the player apparatus is generable based on the format information and the model information stored in the storage portion;
a content transmitting portion that transmits a list of content data extracted by the control portion to the player apparatus; and
a container converting portion that, after the content transmitting portion transmits the list, when the player apparatus makes a reproduction request or a transfer request for content data included in the list, generates content data reproducible by the player apparatus by converting a container format unusable by the player apparatus into a container format usable by the player apparatus based on the information of the container format stored in the storage portion without executing a decoding process of multimedia data included in the content data in the container format unusable by the player apparatus and an encoding process of multimedia data acquired as a result of the decoding process.

19. The device for generating content data as defined in claim 18, further comprising a content analyzing portion that analyzes content data in the container format unusable by the player apparatus, wherein the control portion determines whether the content data reproducible by the player apparatus is generable based on an analysis result conducted by the content analyzing portion.

20. The device for generating content data as defined in claim 18, wherein the container converting portion rewrites an identifier identifying a codec of the multimedia data to generate the content data reproducible by the player apparatus including the multimedia data with the identifier rewritten.

21. The device for generating content data as defined in claim 20, wherein the codec of the multimedia data is MPEG-4 AAC and wherein the codec corresponding to the identifier rewritten by the container converting portion is MPEG-2 AAC.

22. The device for generating content data as defined in claim 21, wherein the MPEG-4 AAC is a codec acquired by adding expanded functions to the MPEG-2 AAC, and wherein the container converting portion generates the content data reproducible by the player apparatus only when the expanded functions of the MPEG-4 AAC are not utilized in content data in the container format unusable by the player apparatus.

23. The device for generating content data as defined in claim 18, wherein the container converting portion generates the content data reproducible by the player apparatus by setting a time interval of alternate storage of video data and audio data included as the multimedia data in the content data reproducible by the player apparatus equal to or less than a predetermined time interval.

24. The device for generating content data as defined in claim 18, further comprising the player apparatus, wherein the player apparatus reproduces the content data generated by the container converting portion.

25. The device for generating content data as defined in claim 18, further comprising a content receiving portion that receives the content data in the container format unusable by the player apparatus from a server apparatus connected via a network, wherein the content transmitting portion transmits the content data reproducible by the player apparatus generated by the container converting portion to the player apparatus connected via the network.

26. The device for generating content data as defined in claim 18, wherein the container format unusable by the player apparatus is MP4.

27. The device for generating content data as defined in claim 18, wherein the container format usable by the player apparatus is MPEG2-TS.

28. The device for generating content data as defined in claim 18, wherein the container format usable by the player apparatus is MPEG2-TTS.

29. A method for generating content data of generating content data reproducible by a player apparatus by using a container format usable by the player apparatus, comprising:
an information reading step of reading format information at least including information of the container format and encoded information of multimedia data included in the content data, and model information including information of at least a type, a model, or a reproduction capability of the player apparatus, from a storage portion;
a data extracting step of extracting content data in a container format unusable by the player apparatus, the content data from which content data reproducible by the player apparatus is generable based on the format information and the model information read at the information reading step;
a content transmitting step of transmitting a list of content data extracted at the data extracting step to the player apparatus; and
a container converting step of, after the list is transmitted at the content transmitting step, when the player apparatus makes a reproduction request or a transfer request for content data included in the list, generating content data reproducible by the player apparatus by converting a container format unusable by the player apparatus into a container format usable by the player apparatus based on the information of the container format read at the information reading step without executing a decoding process of multimedia data included in the content data in the container format unusable by the player apparatus and an encoding process of multimedia data acquired as a result of the decoding process.

30. A computer readable recording medium recording the method for generating content data as defined in claim 29.
